(19) United States
(12) Patent Application Publication
(10) Pub. No.: US 2010/0293003 A1
(43) Pub. Date: Nov. 18, 2010

(54) Personal Medical Data Device and Associated Methods

(76) Inventor: Fred E. Abbo, La Jolla, CA (US)

Correspondence Address: John Karl Buche;BUCHE & ASSOCIATES, P.C., 875 PROSPECT, SUITE 305, LA JOLLA, CA, 92037, US

(21) Appl. No.: 12/770,123

(22) Filed: Apr. 29, 2010

Related U.S. Application Data
(60) Provisional application No. 61/173,870, filed on Apr. 29, 2009.

(51) Int. Cl. G06Q 50/00; G06F 17/30; G06F 3/048

(52) U.S. Cl. 705/2; 707/610; 715/773; 707/706; 715/743; 707/805; 707/E17.046; 715/810; 707/E17.108

(57) ABSTRACT

Disclosed is an improved method and related electronic applications for logging personal medical data.

### CROSS-REFERENCE TO RELATED APPLICATIONS

This application claims the priority of U.S. Prov. Pat. App. Ser. No. 61/173,870 (filed Apr. 29, 2009) entitled “A personal Medical Data Device & Associated Methods.”

### STATEMENT REGARDING FEDERALLY SPONSORED RESEARCH OR DEVELOPMENT

Not applicable.

### BACKGROUND OF THE INVENTION

1. Field of Invention

The present application is in the field of methods and devices for logging and/or tracking personal medical data.

2. Background of the Invention

Typically, patient medical records are kept and maintained by doctors rather than by the patients themselves. Patients with multiple doctors are constantly troubled with communicating medical information maintained at one establishment to medical practitioners at another establishment. Without medical records on hand, the patients are forced into timely endeavors to gather the stated information. Furthermore, patients that wish to track their medical records must do so via hard copy or transcribe their medical information to a storage medium for later conversion to a hard copy.

In addition, the current practices for the maintenance of personal medical records may cause problems for those patients who monitor a physical malady or medical condition because there is not a quick and easy way to personally assess the progress or trends of the condition. Relatedly, the current maintenance practices for personal medical records do not provide a quick and easy way for patients who receive regular lab tests to: (1) personally compare the result of the most recent test with the result of past tests, (2) compare test results with a target optimal result, in graphical format, or (3) extrapolate the graphical representation of test results to detect a favorable or unfavorable trend; or (4) provide to any new consultant doctor a complete record of all of their previous laboratory test results, and imaging procedures.

Moreover, patients are frequently asked to fill out forms which indicate their major diagnoses, injuries, operations, hospitalizations, current and past medications, allergies, immunizations, family and social history, and all previous significant clinical events (e.g., consultations and imaging procedures) before entering a medical consult or doctor's appointment. Completion of these forms can be difficult for elderly patients, unconscious patients, or patients who have not accessed their medical records for extended periods of time. Military personnel frequently move quickly from place to place, and their medical record may not be available in a timely manner for unforeseen emergencies. Furthermore, patients frequently return from a doctor visit and forget some of the important information resulting from the visiting. Other patients have difficulty remembering the follow-up action recommended by the doctor (e.g., telephone reports, laboratory tests to be done, or a next office visit).

### SUMMARY OF THE INVENTION

Accordingly, it is an object of the present application to provide at least one method and associated system for logging and/or tracking personal medical information, and for facilitating and improving the medical care process for the patient.

It is a further object of the present application to provide at least one method and system for logging the results of medical lab tests wherein previous results of the same test may be compared, test result goals and progress may realistically be judged, and unfavorable test result graphical trends detected early enough to take timely preventative action. This would include the use of a programmatically generated data plots or graphs.

It is another object of the present application to provide at least one method and associated electronic applications for communicating accurate medical history or data to multiple doctors, either in routine or emergency situations, without the necessity of gathering medical records from multiple sites.

### BRIEF DESCRIPTION OF THE FIGURES

Other objectives of the invention might become apparent to those skilled in the art once the invention has been shown and described. The manner in which these objectives and other desirable characteristics can be obtained is explained in the following description and attached figures in which:

FIGS. 1, 2A, 2B, 2C, 3A, 3B, 3C, 4A, 4B, 4C, 5A, 5B, 6A, 6B, 7A, 7B, 8A, 8B, 9A, 9B, 9C, 10A, 10B, 11A, 11B, 11C, 12A, 12B, 12C, 13A, 13B, 13C, 13D, and 13E are depictions of software interfaces that may be used for implementing the system herein described;

FIG. 14 is a flow diagram for one method for logging personal medical information; and,

FIG. 15.1-15.21 are screenshots of a preferable embodiment of the present invention.

It is to be noted, however, that the appended figures illustrate only typical embodiments of this invention and are therefore not to be considered limiting of its scope, for the invention may admit to other equally effective embodiments that might be appreciated by those reasonably skilled in the relevant arts. Also, figures are not necessarily made to scale but are representative.

### DETAILED DESCRIPTION OF PREFERRED EMBODIMENTS

In general, the systems and methods disclosed are preferably for logging, tracking, and managing personal medical records and medical appointments/tasks. The system also provides internet access to information about specific medications or medical treatments. According to this invention, personal medical data is preferably re-writably provided to at least one categorized electronic database, preferably via the operation of a mobile/portable electronic device featuring at least one visual output display (e.g., cell phone, Personal Digital Assistant, and etcetera). Preferably, the medical data may be provided to the database at any time or location xxx. After data entry, the data may be updated, sorted, filtered, and/or programmatically manipulated. It is further contemplated that the data may be provided to, or received from, the mobile/portable electronic device via synchronization (wireless or hardwired) with a computer means (e.g., desk-top, lap top, or other type of computer). Ultimately, the data is selectively and electively recallable for display (whether graphically, symbolically, or otherwise) on the mobile/portable electronic device.

Typically, a computer software might be installed to the mobile/portable electronic device for: (1) categorized data entry to at least one database; (2) sorting, updating, filtering, or programmatically manipulating data; (3) selective and elective data recall from the database; and (4) visual data display or data communication/transfer. A launch code or password is preferable for initiating the software. User operation of the software may preferably be accomplished via user interaction with elements or command buttons on a software interface displayed on the visual output display of the mobile/portable electronic device.

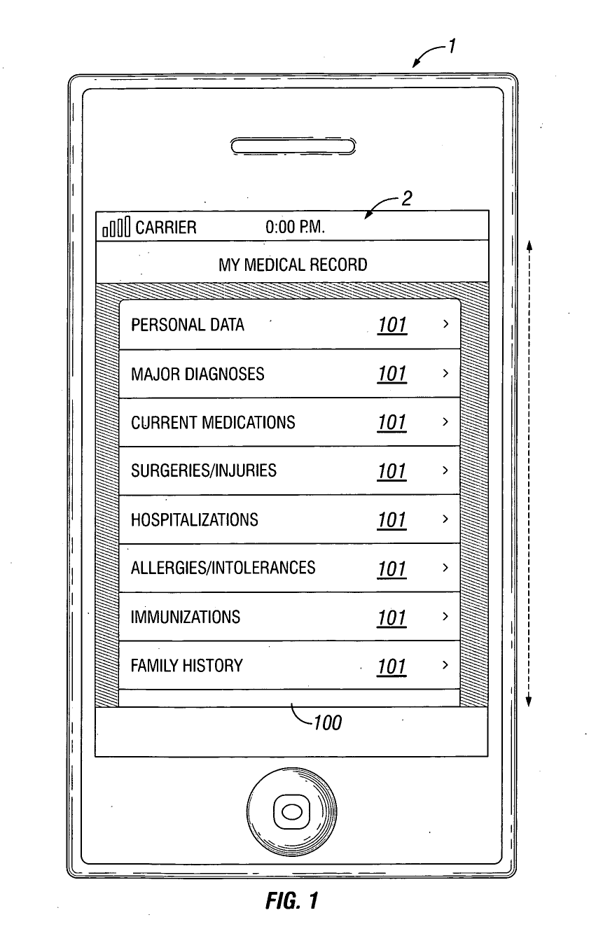

FIG. 1 depicts a typical mobile/portable device 1 with a visual output display 2 that shows a preferable initial software interface including a root menu 100. Preferably, each menu item defines a data category. For example, a suitable root menu 100 may comprise the following items: personal data; major diagnoses; current medications; surgeries or injuries; hospitalizations; allergies or intolerances; immunizations; hereditary data or family history; doctors or hospitals; clinical events; lab tests or test results; office visits; reminders; and, documents. Other medical information will be ascertainable by those skilled in the art.

Still referring to FIG. 1, each menu item suitably defines a command button 101 that provides a link to a software interface for displaying data within the subject category. As depicted in the figure, if the visual output display 2 is not of sufficient dimensions for displaying the entire root menu 100, the display may preferably feature a scrolling element. Preferably, for devices with a pressure sensitive display, scrolling is accomplished via directional touching, such as used in current iPhone® applications. Scrolling elements and methods will be well known to those skilled in the art. Generally, each software interface discussed further below preferably features a home button 10 for returning the user to the root menu 100 on the FIG. 1 interface.

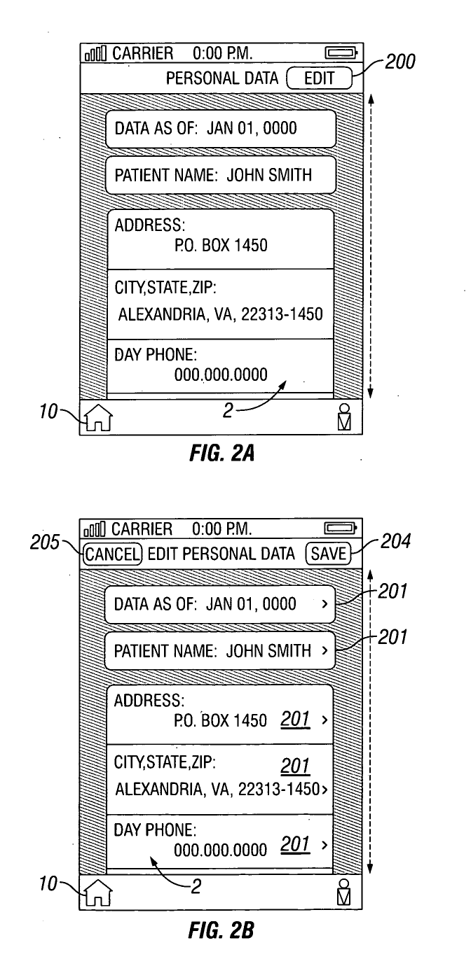

FIG. 2A depicts a preferable software interface for displaying data within the “personal data” category. The “personal data” category may comprise the following data: the calendar date of the most recent data input or modification; the user's name; the user's address; the user's phone number (day and night); the user's calendar date of birth; the user's primary and secondary insurance carriers; the user's primary insurance identification or policy number; the user's pharmacy of choice and the associated telephone number; the users; height, weight, gender, and body mass index (including the associated interpretation); the user's emergency contact information including the contact's name, relationship to the user, and telephone number; and whether the patient has a living will or not. As seen in the figure, the interface preferably displays the “personal data.” As with all interfaces in the present software, if the dimensions of the visual output display 2 are not sufficient to show all of the data types within the personal data category, the software interface preferably features a scrolling element.

Still referring to FIG. 2A, the software interface further comprises a command button 200 for enabling data entry. Preferably, user interaction with the command button 200 (whether by cursor or by touch for pressure sensitive displays) produces the software interface depicted by FIG. 2B. FIG. 2B is visually similar to FIG. 2A, but further comprises command buttons 201 associated with each data type within the “personal data” category.

Still referring to FIG. 2B, the command buttons 201 are for initiating data entry or data modification. Interaction with the command button 201 preferably produces the software interface of FIG. 2C comprising data entry elements (e.g., text entry boxes 206 or check boxes). Still referring to FIG. 2C, the data entry elements are preferably empty for data entry or editably pre-filled for data modification/updating. Data is preferably entered and edited via a keyboard 3 on the mobile/portable electronic device. The keyboard 3 may preferably be a Virtual QWERTY keyboard produced by the software, or a QWERTY keyboard hardwired to the electronic device. The FIG. 2C interface further comprises: (1) a command button 202 for completing the data entry, and (2) a command button 203 for canceling the data entry. Both command buttons 202, 203 suitably return the user to the software interface of FIG. 2B.

Referring once again to FIG. 2B, the software interface further comprises: (1) a command button 204 for saving the recent data entry, and (2) a command button 205 for canceling the data entry. Both command buttons 202, 203 suitably return the user to the software interface of FIG. 2A for displaying the “personal data.”

Not all data entry or modification must be accomplished by the user. Certain data may be automatically generated or programmatically derived from the other data entries. For example, the calendar date may be automatically generated from the settings of the mobile/portable electronic device. For another example, the body mass index and the associated interpretation may be derived from the “height” and “weight” data entries (body mass index equals the user's weight (in kg) divided by the squared height (in m) wherein the interpretation is “normal” if the result is between 18.5 and 24.9 kg/m², “overweight” if between 25 and 29.9 kg/m², and “obese” if 30 kg/m² or higher).

FIGS. 1 through 2C provide an example of basic software use. Initially, a first-time user may launch the software and select “personal data” from the root menu 100 displayed by the FIG. 1 interface. The activated link suitably produces the FIG. 2A interface. Next, interaction with the command button 200 produces the FIG. 2B, thereby enabling data entry. Thereafter, the user preferably selects a data type for adding/modifying data and subsequently interacts with the associated command button 201 to initiate data entry via the FIG. 2C interface. After data entry/modification, the software might programmatically determine data values derived from other data entries. Later, the user may interact with the command button 202 to complete the entry and produce the FIG. 2B interface. Command button 204 preferably saves the data. Finally, the user may return to the root menu 100 or exit the software.

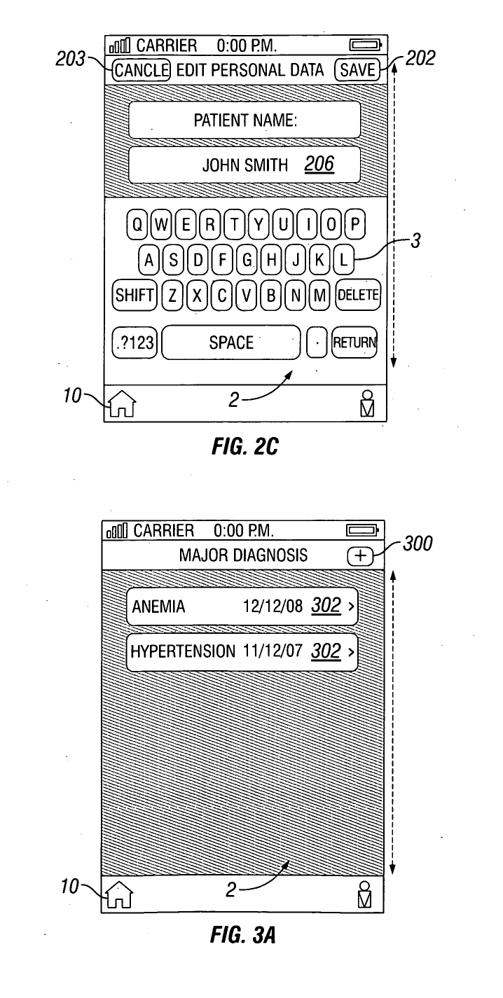

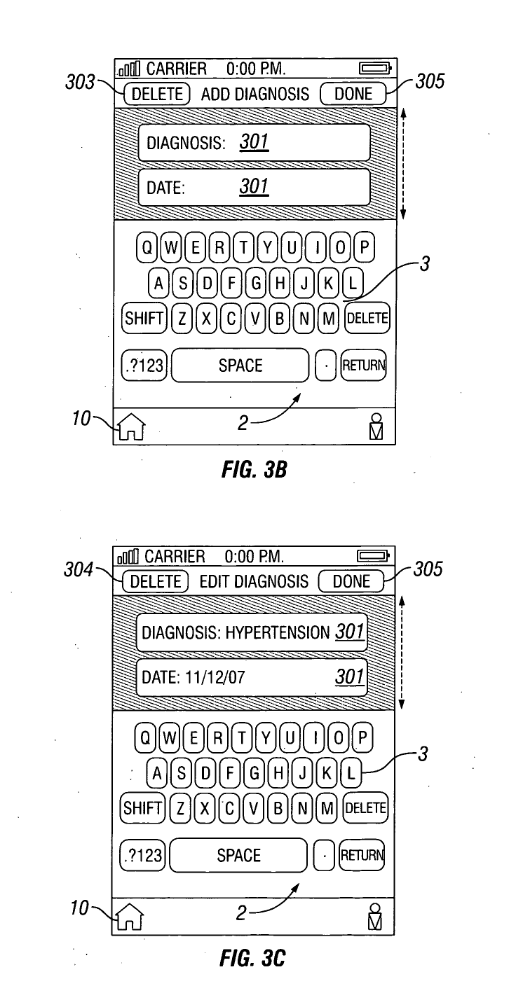

FIG. 3A depicts a preferable software interface for displaying data within the “major diagnoses” category. The “major diagnoses” should preferably include any diagnosis made by a medical practitioner regarding the user (preferably regarding the health of the user, e.g., Anemia, High Blood Pressure, Hyperlipidemia, and any other disease or ailment) and the corresponding calendar date. As seen in the figure, the interface preferably comprises a sectioned view of the “diagnoses data” (each section comprising a diagnosis and the corresponding calendar date).

Still referring to FIG. 3A, the software interface further comprises: (1) a command button 300 for enabling data entry, and (2) command buttons 302 for initiating data modification. Preferably, user interaction with the command button 300 produces the software interface depicted by FIG. 3B. Alternatively, interaction with a command button 302 preferably produces the software interface of FIG. 3C. FIG. 3B and 3C display text entry boxes 301 entering or modifying “diagnosis data” (e.g. date and diagnosis) respectively. As illustrated by the figures, a text entry box 301 preferably appears empty for data entry or editably pre-filled for data modification. Data is preferably entered or edited via a keyboard 3 on the mobile/portable electronic device, as discussed above.

The interface of FIGS. 3B and 3C further comprises a command button 305 for saving the data entry, and a command button for canceling 303 or deleting 304 the data entry. All command buttons 305, 303, 304 suitably produce the software interface of FIG. 3A for displaying the data.

FIGS. 1, 3A, and 3B provide another example of basic software use. Initially, a first-time user may launch the software and select “major diagnoses” from the root menu 100 displayed by the FIG. 1 interface. The activated link produces the FIG. 3A interface. Next, interaction with the command button 300 preferably produces the FIG. 2B interface for data entry. After data entry, the command button 305 saves the entry and returns the user to the FIG. 3A interface. Optionally, data modification is preferably initiated via interaction with command button 302, and accomplished on the FIG. 3C interface as discussed above. Finally, the user may return to the root menu or exit the software. Other styles of buttons may be used to accomplish the same end and “radio” is not intended to be limiting or prevent uses of suitable equivalents.

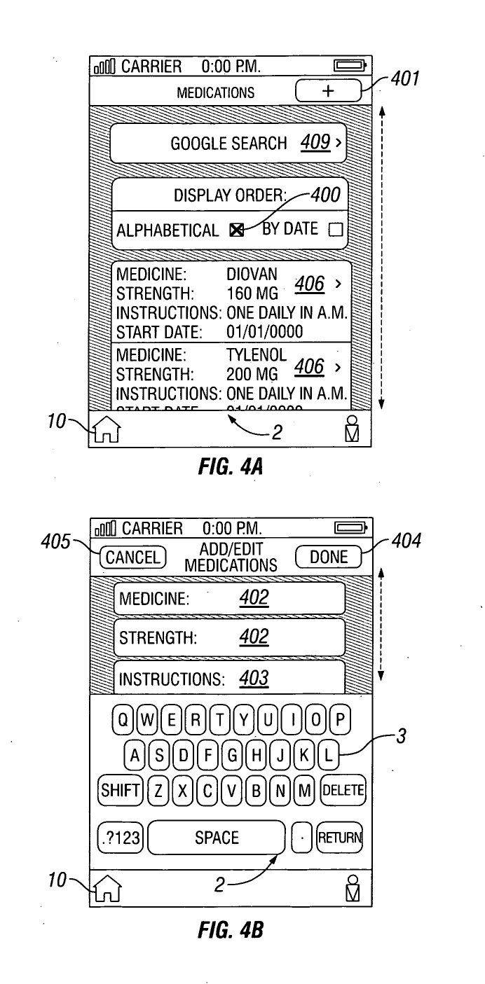

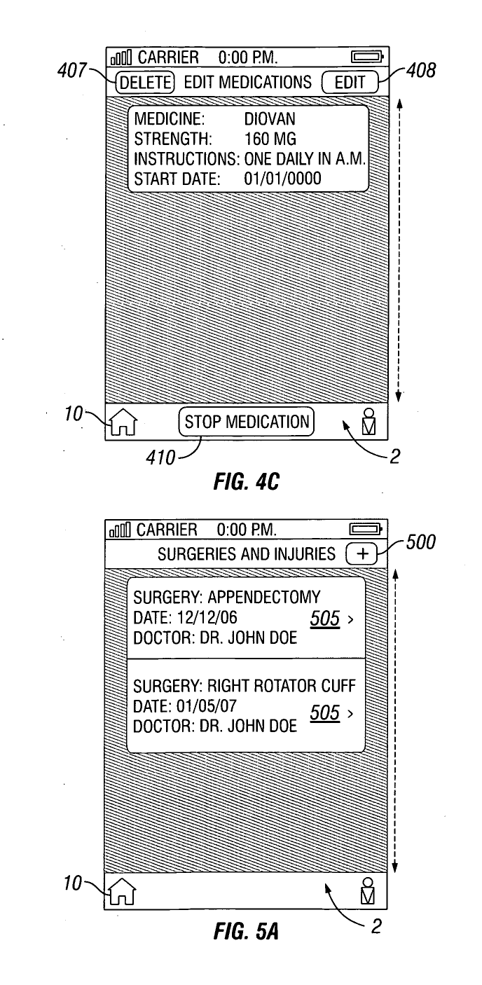

FIG. 4A depicts a preferable software interface for displaying data within the “medications” or “current medications” category. The “medications” database should preferably comprise the name, strength or dose, administration instructions, and the calendar date for initial administration of any prescription or over the counter drugs (suitably including vitamins, supplements, and the like) administered to the software user. As seen in the figure, the FIG. 4A interface preferably comprises a sectioned list of medication data (i.e., a section per individual medication comprising each of the data types mentioned in the preceding sentence). It should be noted that the stated data is not the only type of data that is suitably within the category of “medications,” and it is contemplated that more data could be provided to the category without affecting the operation of the software (for example, the prescribing doctor, notes on the medicine, and side-effects or dangers). It should be also noted that, as in all interfaces of the present application, if the dimensions of the output display 2 are not sufficient to show all data within the category, a scrolling element could be provided to the display 2.

Still referring to FIG. 4A, the software interface preferably comprises a radio button 400 with options for sorting the “current medications” data displayed thereby. For example, the radio button 400 depicted in FIG. 4A features (1) an option for sorting the sections of data alphabetically according to the medication name and (2) an option for sorting the sections of data chronologically according to the dates of initial administration. Although two options are provided in the figure, the radio button 400 may suitably feature additional sorting criteria, like, for example, reverse alphabetical or reverse chronological or any other sorting criteria known to those skilled in the art.

FIG. 4A also comprises a command button 409 for initiating an internet web browser plus search engine whereby the user may research the particular medications within the “medications” category.

Still referring to FIG. 4A, the software interface further comprises a command button 401 for adding a section of current medication data. Preferably, user interaction with the command button 401 produces the software interface depicted by FIG. 4B. FIG. 4B preferably comprises data entry elements respectively representing the data types that compose the FIG. 4A sections of “medication” data (e.g., name, dose, instruction, and start date). The data entry elements may preferably be text entry boxes, drop down lists, or a list box. FIG. 4B exemplarily depicts text entry boxes 402 for the inputting medicine name and dose or strength. Also depicted is a drop down list 403 for entering instructions, but the list items are not shown. A text entry box 402 for entering the initial administration date is not shown in the figure, but is suitably displayable via a scrolling element in the FIG. 4B interface.

Still referring to FIG. 4B, data is preferably entered and edited in the text entry boxes 402 via a keyboard 3 on the mobile/portable electronic device. Data is preferably entered and edited on the drop down list 403 via cursor interaction with an item in the drop down list 403 or via touched selection of items in the list for mobile/portable devices with pressure sensitive displays. Operation of a drop down list will be further discussed below in connection with the later figures. In the “current medications” category, a first drop down list for medicine administration instructions may include, but not necessarily be limited to any of the following types of information: “one pill daily;” “one pill twice daily;” “one pill three times daily;” “one pill four times daily;” “one puff daily;” “one puff twice daily;” “one puff three times daily;” “one puff four times daily;” “one inhalation daily;” “one inhalation twice daily;” “one inhalation three times daily;” “one inhalation four times daily;” “as needed;” or, any other phrase communicating frequency and manner of administration. A second drop down list for medicine administration instructions preferably may comprise information that includes but is not limited to the following: “in the morning;” “in the evening;” “at bed time;” “as needed;” or any other language for communicating the timing of medicine administration.

Still referring to FIG. 4A, it should be noted that in addition to listing the patients current medications, there may also preferably be a list of old medications (including the start date, stop date, and reason for cessation).

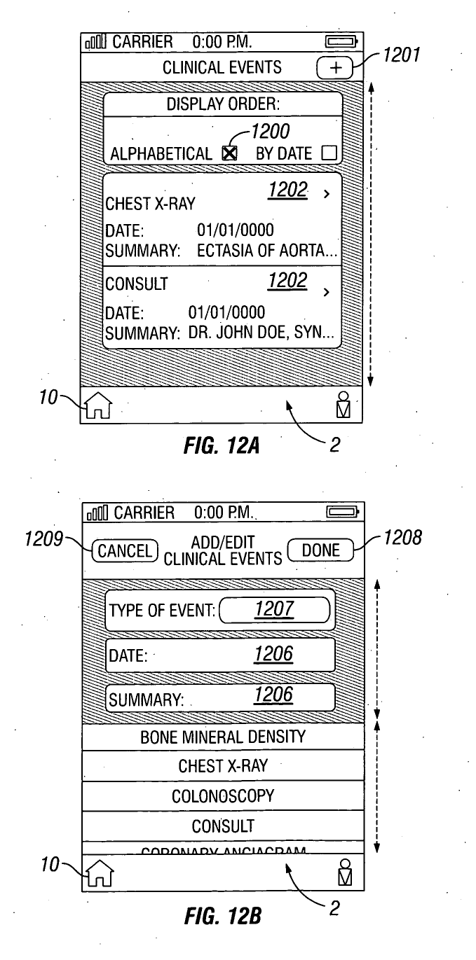

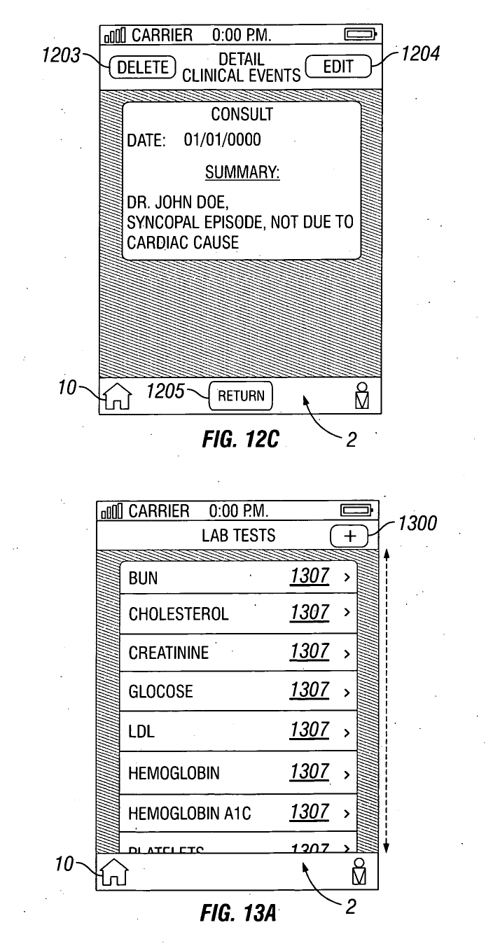

The FIG. 4B interface further comprises: (1) a command button 404 for saving the entered data, and (2) a command button 405 for canceling the data entry. Interaction with either command button 404, 405 preferably produces the software interface of FIG. 4A. As discussed further below in connection with FIGS. 12A through 12C, interacting with the command button 404 also programmatically produces a data entry under the category of “clinical events.”

Referring again to FIG. 4A, the software interface also features command buttons 406 for enabling data modification. Preferably, interaction with a command button 406 produces the software interface depicted by FIG. 4C. FIG. 4C is similar to FIG. 4A except that only the single section of the “current medication” data associated with the selected command button 406 is displayed. For example, the FIG. 4C interface is the result of the command button 406 associated with “Diovan” medication on FIG. 4A.

The FIG. 4C interface preferably comprises: a command button 408 for producing the FIG. 4B interface to edit the subject data (edited in the manner discussed above in connection with data entry); a command button 407 for deleting the subject data; and a command button 410 for stopping the medication (i.e., removing the medication from the category and producing a “clinical event” data entry, as discussed below, for memorializing the cessation of the subject medication). Similar to the interfaces discussed above, interaction with any command button 404, 405, 407, 408, 410 preferably returns the user to the updated data display of the FIG. 4A software interface.

FIG. 4B generally functions the same whether the user directed to the interface from FIG. 4A or 4C (i.e., data entry v. data modification). However, the data entry elements of FIG. 4B are editably pre-filled with the subject data of FIG. 4C when data modification is initiated via the command button 408.

FIGS. 1 and 4A through 4C provide another example of basic software use. Initially, a first-time user may launch the software and select “current medications” from the root menu 100 displayed on the FIG. 1 interface. The activated link preferably produces the FIG. 4A interface. Next, the command button 401 suitably produces the FIG. 4B interface for data entry. After data entry, the user may interact with the command button 404 on the FIG. 4B interface to save the data entry and produce a data entry under the category of “clinical events,” as discussed further below. Simultaneously, interaction with the command button 404 preferably returns the user to the FIG. 4A interface for displaying the fresh data. At the user's option, interaction with the command button 406 associated with a data section produces the FIG. 4C interface. Via the FIG. 4C interface, the subject data may be deleted (command button 407), stopped (command button 410), or modified (command button 408) as discussed above. As mentioned above, an indication that the medication dosage has ceased (command button 410) produces a data entry into the “clinical events” database, as discussed below. In any event, interaction with command buttons 404, 405, 407, 408, 410 preferably returns the user to the FIG. 4A interface with the modified data displayed thereon. From the FIG. 4A interface, the data may (1) be sorted by medicine name or chronologically via interaction with the radio button 400, or (2) researched on the internet (via command button 409). Finally, the user may return to the root menu or exit the software.

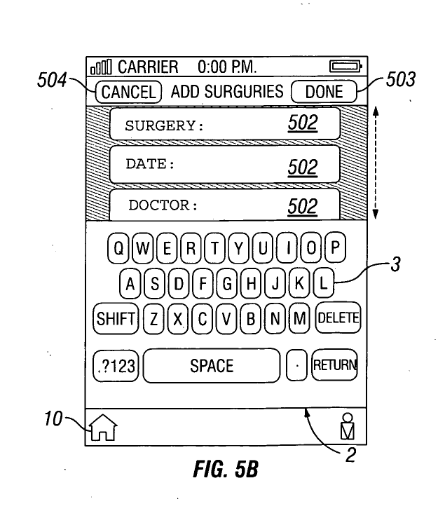

FIG. 5A depicts a preferable software interface for displaying data within the “surgeries and injuries” category. Data within the “surgeries and injuries” category should preferably comprise a type of surgery or an injury necessitating a surgery, the calendar date of occurrence, and the doctor involved. As seen in the figure, the interface preferably comprises a data section per surgery or injury (i.e., sections of data comprising the data types disclosed in the preceding sentence). The sections should preferably be displayed on the FIG. 5A interface in chronological order. It should be noted that the stated data is not the only type of data that is suitable for the category of “surgeries and injuries,” and it is contemplated that more data could be provided to the category without affecting the operation of the software (for example, the operating doctor's contact information, notes, or advice about the surgery).

Still referring to FIG. 5A, the software interface further comprises: (1) a command button 500 for adding a section of “surgeries and injuries” data, and (2) a command buttons 505 for editing an associated section of “surgeries and injuries” data. Preferably, interaction with either command button 500, 505 produces the software interface depicted by FIG. 5B. FIG. 5B preferably comprises a data entry elements respectively representing the related data types within the FIG. 5A data sections. The text boxes 502 might be empty for the addition of data (i.e., for command button 500) or filled with pre-entered data associated with the command button 505 for editing the data. Data is preferably entered and edited in the text entry boxes 502 via a keyboard 3 as discussed above. A scrolling element may compose the interface, if necessary.

The FIG. 5B interface further comprises: (1) a command button 503 for saving the entered data and (4) a command button 504 for canceling or deleting a data entry. Interaction with either command button 503, 504 preferably returns the user to the software interface of FIG. 5A for displaying the data.

FIGS. 1, 5A and 5B provide another example of basic software use. Initially, a first-time user may launch the software and select “surgeries and injuries” from the root menu 100 on the FIG. 1 interface. The activated link preferably produces the FIG. 5A interface. Next, the command button 500 preferably initiates data entry and produces the interface of FIG. 5B with blank text entry boxes 502. After data entry, the command button 503 saves the data entry and returns the user to FIG. 5A interface for viewing the data. At the user's option, interaction with a command button 501 initiates data editing of the associated with corresponding data and produces the FIG. 5B interface. After data modification, the command button 503 might preferably save the modified data entry and for return the user to the FIG. 5A interface. Finally, the user may return to the root menu or exit the software.

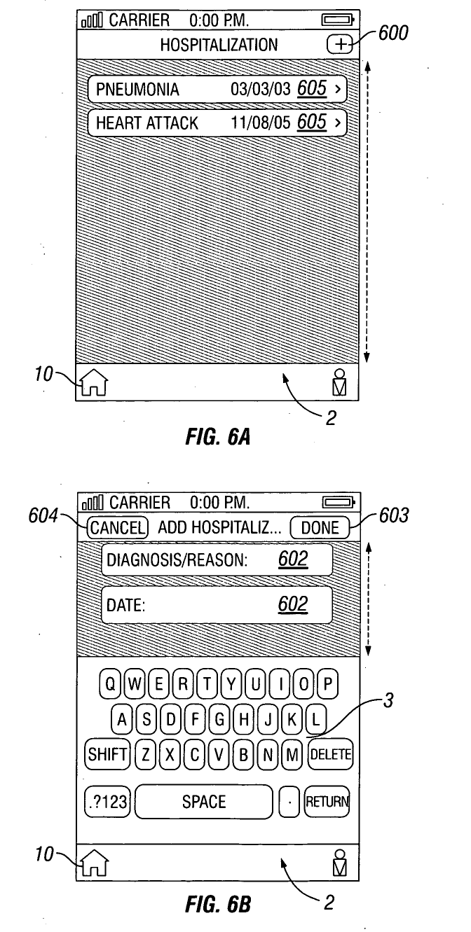

FIG. 6A depicts a preferable software interface for displaying data within the “hospitalizations” category. Data within the “hospitalizations” category should preferably comprise a diagnosis or description of the reason for the user's hospitalization and the associated calendar date. As seen in the figure, the FIG. 6A interface preferably comprises a relatedly sectioned view of the data (i.e., a section per hospitalization comprising the data types mentioned in the preceding sentence). The data should preferably be displayed on the FIG. 6A interface in chronological order. It should be noted that the stated data is not the only type of data that is suitable for the category of “hospitalizations,” and it is contemplated that more data could be provided to the category without affecting the operation of the software (for example, the hospital's contact information, notes or advice about the hospitalization).

Still referring to FIG. 6A, the software interface further comprises: (1) a command button 600 for adding a section of “hospitalizations” data, and (2) command buttons 605 for editing a previously entered “hospitalizations” data. Preferably, user interaction with either command button 600, 605 produces the software interface depicted by FIG. 6B. FIG. 6B preferably comprises a data entry elements respectively representing the data types of FIG. 6A. The text boxes 602 are preferably empty for the addition of data (i.e., for command button 600) or pre-filled with data for editing (i.e., for command button 605). Data is preferably entered and edited in the text entry boxes 602 via a keyboard 3 as discussed above.

The FIG. 6B interface further comprises: (1) a command button 603 for saving the entered data, and (2) a command button 604 for canceling or deleting a data entry. Interaction with either command button 603, 604 might preferably return the user to the software FIG. 6A interface.

FIGS. 1, 6A and 6B provide another example of basic software use. Initially, a first-time user may launch the software and select “hospitalizations” from the root menu 100 displayed one the FIG. 1 interface. The activated link produces the FIG. 6A interface. Next, the user might preferably interact with the command button 600 to produce the FIG. 6B interface with blank text entry boxes 602. After data entry, the command button 603 saves the data entry and simultaneously returns the user to the FIG. 6A interface with the fresh data displayed thereon. Optionally, a command button 601 associated with the data produces the FIG. 6B interface with pre-filled entry boxes 602 for editing the data. After data modification, the command button 603 preferably saves the modified data and returns the user to the FIG. 6A interface. Finally, the user may return to the root menu or exit the software.

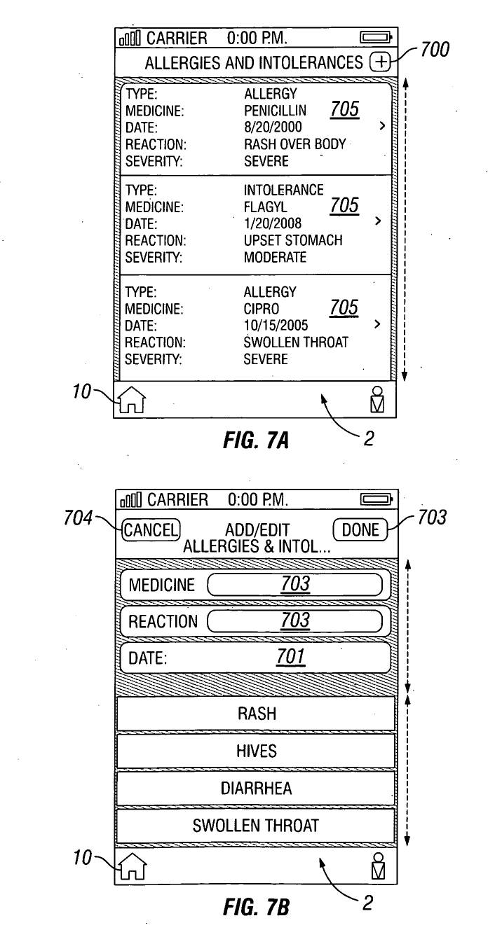

FIG. 7A depicts a preferable software interface for displaying data within the “allergies or intolerances” category. Data within the “allergies or intolerances” category should preferably comprise the type (e.g., allergy or intolerance), the provoking substance, the calendar date when the allergy or intolerance was experienced or discovered, the user's reaction to the allergy or intolerance, and the severity of the reaction. As seen in the figure, the FIG. 7A interface preferably comprises a relatedly sectioned view of “allergy and intolerance” data (i.e., a section comprising each of the data types mentioned in the preceding sentence). The stated data sections should preferably be displayed chronologically. It should be noted that the stated data is not the only type of data that is suitably within the category of “allergies or intolerances,” and it is contemplated that more data could be provided to the category without affecting the operation of the software (for example, medications for treating the allergy and/or reaction, duration of the reaction, and notes).

Still referring to FIG. 7A, the software interface further comprises: (1) a command button 700 for adding a section of data and (2) command buttons 705 for editing previously entered data. Preferably, user interaction with either command button 700, 705 produces the software interface depicted by FIG. 7B. FIG. 7B preferably comprises data entry elements respectively representing the data types of FIG. 7A. The data entry elements may preferably be text entry boxes, drop down lists, or a list box. The text entry elements might be empty for the addition of data (i.e., for command button 700) or pre-filled for editing the data (i.e., for command button 705). Preferably, text entry boxes 702 are suitable for entering the provoking substance data and calendar date data. Preferably, drop down lists 703 are suitable for entering the type, the reaction, and the severity data.

Suitably, the first drop down list for the type (allergy or intolerance) preferably may comprise information that includes but is not limited to: “allergy;” and, “intolerance.” As exemplarily depicted in FIG. 7B, the second drop down list 703 for reaction type preferably may comprise information that includes but is not limited to: “rash;” “hives;” “diarrhea;” “swollen throat;” or, any other symptom of an allergic or intolerant reaction. A third drop down list for severity preferably may comprise information that includes but is not limited to: “mild;” “moderate;” “severe;” or, any other language indicating the harshness of the reaction.

Still referring to FIG. 7B, data is preferably entered and edited on the drop down list 703 via cursor interaction with an item in the drop down list 703 or via touched selection of items in the list for mobile/portable devices with pressure sensitive displays. Although not depicted in the figure, data is preferably entered and edited in the text entry boxes 702 via a keyboard as discussed above (e.g., wherein a keyboard 3 replaces the dropdown list).

The FIG. 7B interface further comprises: (1) a command button 703 for saving the entered data 7, and (2) a command button 604 for canceling or deleting a data entry. Interaction with either command button 603, 604 might preferably return the user to the software interface of FIG. 6A for displaying the fresh data.

FIGS. 1, 7A and 7B provide another example of basic software use. Initially, a first-time user may launch the software and select “allergies or intolerances” from the root menu 100 displayed by the FIG. 1 interface. The activated link preferably produces the FIG. 7A interface. Next, the command button 700 suitably produces the FIG. 7B interface with blank text entry elements (i.e., text boxes 702 and drop-down lists 703). Thereafter, data entry is accomplished by at least one text entry box 702 (preferably via a keyboard) or drop down list 703. Subsequently, the user may interact with the command button 704 on the FIG. 7B interface to save the data entry and return the user to the FIG. 7A interface with the fresh data displayed thereon. Optionally, the user may interact with a command button 705 associated with the associated data to produce the FIG. 7B interface for editing the subject data. After data modification, the command button 703 suitably saves the modified data entry and produces the FIG. 7A interface. Finally, the user may return to the root menu or exit the software.

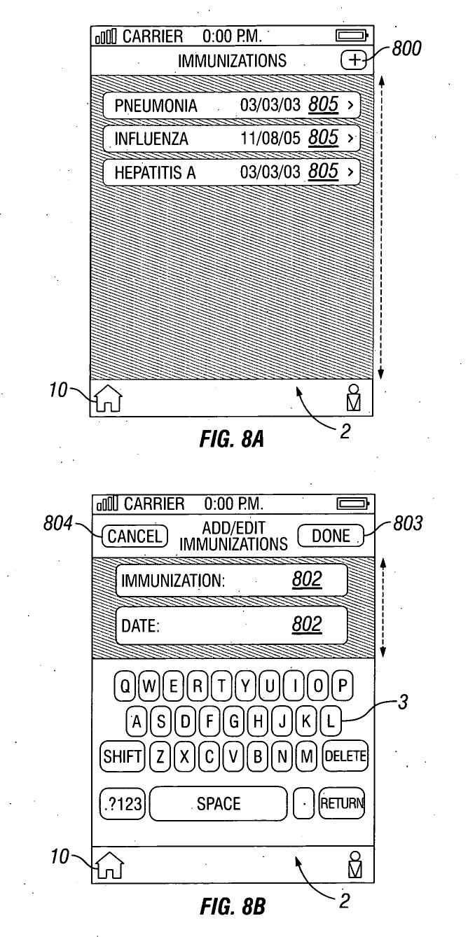

FIG. 8A depicts a preferable software interface for displaying data within the “immunizations” category. Data within the “immunizations” category should preferably comprise an immunization and the associated calendar date. As seen in the figure, the FIG. 8A interface preferably comprises sections of data (i.e., sections comprising each of the data types mentioned in the preceding sentence). The data should preferably be displayed on the FIG. 8A interface in chronological order. It should be noted that the stated data is not the only type of data that is suitable for the category of “immunizations,” and it is contemplated that more data could be provided to the category without affecting the operation of the software (for example, the immunizing clinic's contact information, notes, or advice about the immunization).

Still referring to FIG. 8A, the software interface further comprises: (1) a command button 800 for adding a section of data and (2) a command button 805 for editing a previously entered row of data. Preferably, user interaction with either command button 800, 805 produces the software interface depicted by FIG. 8B. FIG. 8B preferably comprises text entry boxes 802 respectively representing the data types composing the sections of FIG. 8A. The text boxes 802 might be empty for the addition of data (i.e., for command button 800) or filled with pre-entered data for editing (i.e., for command button 805). Data is preferably entered and edited in the text entry boxes 802 via a keyboard 3 as stated above.

The FIG. 8B interface further comprises: (1) a command button 803 for saving the data entry, and (2) a command button 804 for canceling or deleting a data entry. Interaction with either command button 803, 804 preferably returns the user to the software interface of FIG. 8A. Also, as discussed below in connection with FIG. 12A through 12C, the addition, deletion, or modification of an immunization data entry programmatically produces a data entry in the “clinical events” database.

FIGS. 1, 8A and 8B provide another example of basic software use. Initially, a first-time user may launch the software and select “immunizations” from the root menu 100 displayed by the FIG. 1 interface. The activated link preferably produces the FIG. 8A interface. Next, the command button 800 suitably produces the FIG. 8B interface with blank text entry boxes 802. After data entry, the command button 803 saves the data entry and returns the user to the FIG. 8A interface. Simultaneously, a data entry into the “clinical event” database is programmatically made, as discussed further below in connection with FIG. 12A through 12C. Optionally, interaction with the command button 801 on the FIG. 8A interface produces the FIG. 8B interface for editing the associated data. After data modification, a command button 803 might save the modified data and for return the user to the FIG. 8A interface. Similar to the addition of data, the modification of data may also simultaneously and programmatically accomplish a data entry into the “clinical event” database, as discussed further below. Finally, the user may return to the root menu or exit the software.

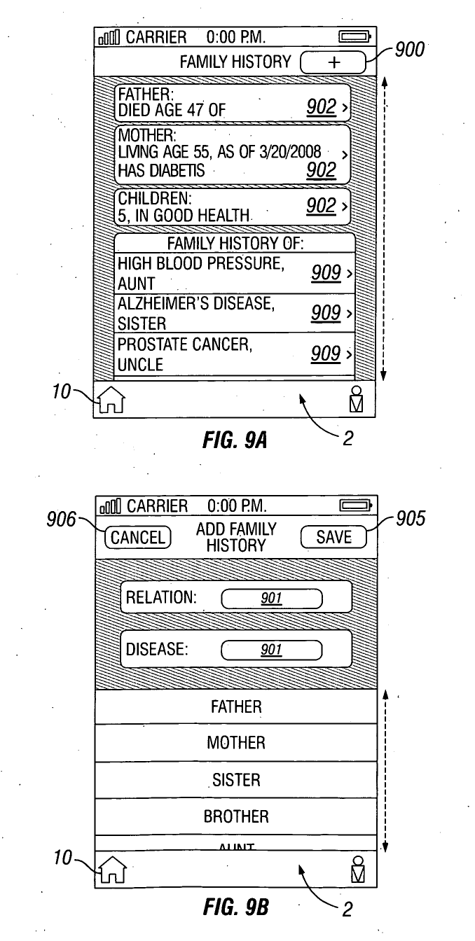

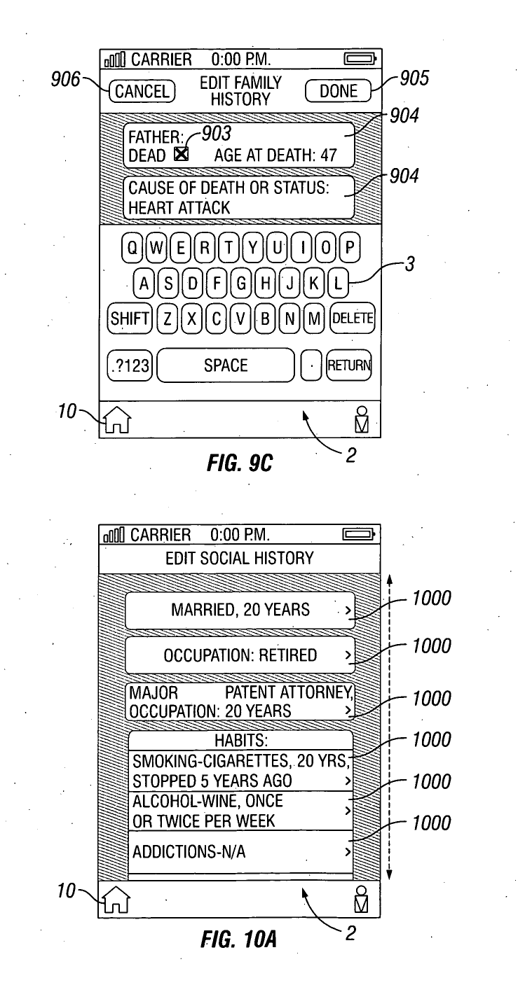

FIG. 9A depicts a preferable software interface for displaying data within the “family history” category. Data within the “family history” category should preferably comprise: the present health of the user's parents and children; and, the family history of specified diseases or medical problems (i.e., the occurrence of medical problems in the history of the father, mother, grandparents, uncles, aunts, and etcetera). The list of specified diseases or medical problems might include: diabetes; high blood pressure; prostate cancer; breast cancer; colon cancer; ovary cancer; pancreas cancer; other kinds of cancer; heart disease; gout; kidney disease; asthma; migraine headaches; psychiatric problems; bleeding problems; epilepsy; tuberculosis; AIDS; stroke; blood clots; neurologic disease; Parkinson's disease; muscle disorder; or any other specific type of disease. As seen in the figure, the FIG. 9A interface preferably comprises a sub-sectioned list for the immediate family member's present health, hereditary diseases, and the non-hereditary diseases. The stated data should preferably be displayed chronologically and relatedly.

Still referring to FIG. 9A, the software interface further comprises a command button 900 for adding the “family history of:” specified diseases or medical problems data. Preferably, user interaction with the command button 900 produces the software interface depicted by FIG. 9B. FIG. 9B preferably comprises data entry elements (preferably, drop down list 901), each element representing the specified disease and the relationship of the family member suffering from the disease.

FIG. 9B exemplarily depicts the drop down list for selecting the relationship of the family member suffering from a particular disease. As depicted in the figure, a drop down list for the identity of a family member within the “family history of:” subsection may preferably comprise information that includes but is not limited to: “father;” “mother;” “sister;” “brother;” “grandparent;” “uncle;” or “aunt.” Although not depicted in the figure, the drop down list for the selection of the particular disease may be accomplished in the same manner as the drop down list depicted. The drop down list 901 for a specific disease within the “family history of:” subsection may comprise information that includes but is not limited to: “cancer;” “heart disease;” “diabetes;” “Parkinson's;” Alzheimer's;” “stroke;” or any other disease.

Referring back to FIG. 9A, the interface preferably comprises a command buttons 909 for the editing of the “family history of:” subsection. The command button 909 preferably produces the software interface of FIG. 9B for editing the associated data and data editing is accomplished in substantially the same manner discussed above for data entry.

Referring again to FIG. 9A, the interface also comprises command buttons 902 for editing the general family data Command button 902 preferably produces the FIG. 9C interface, preferably comprising data entry elements. The data entry elements may preferably be check boxes 901 or text entry boxes 903. Preferably, the text entry elements might be empty for the addition of data or pre-filled for editing the data (i.e., for command button 902). FIG. 9C exemplarily depicts: a check box 903 to indicate whether a family member is alive or dead; and, a text entry box 904 for the age of a family member upon his/her death and cause of death (if applicable). Further text entry boxes 904 are preferable for entering, the number of children parented by the user, and a description of children's health problems, if any. Data is preferably entered and edited in the text entry boxes 903 via a keyboard 3 on the mobile/portable electronic device as discussed above. Also, data is preferably entered and edited on the check boxes 901 via cursor interaction with a check box 901.

Both of the FIGS. 9B and 9C interfaces further comprise: (1) a command button 905 for saving the entered data and (2) a command button 906 for canceling the data entry. Interaction with either command button 905, 906 preferably returns user to the software interface of FIG. 9A for displaying the fresh data.

FIGS. 1, 9A through 9C provide another example of basic software use. Initially, a first-time user may launch the software and select “family history” from the root menu 100 displayed by the FIG. 1 interface. The activated link preferably produces the FIG. 9A interface. Next, interaction with either command button 900 or 902 respectively produces the FIG. 9B or 9C interface with blank text entry elements (i.e., check boxes 903, drop-down lists 901, and text entry boxes 904). After data entry, interaction with the command button 905 suitably saves the data entry and produces the FIG. 9A interface. Finally, the user may return to the root menu or exit the software.

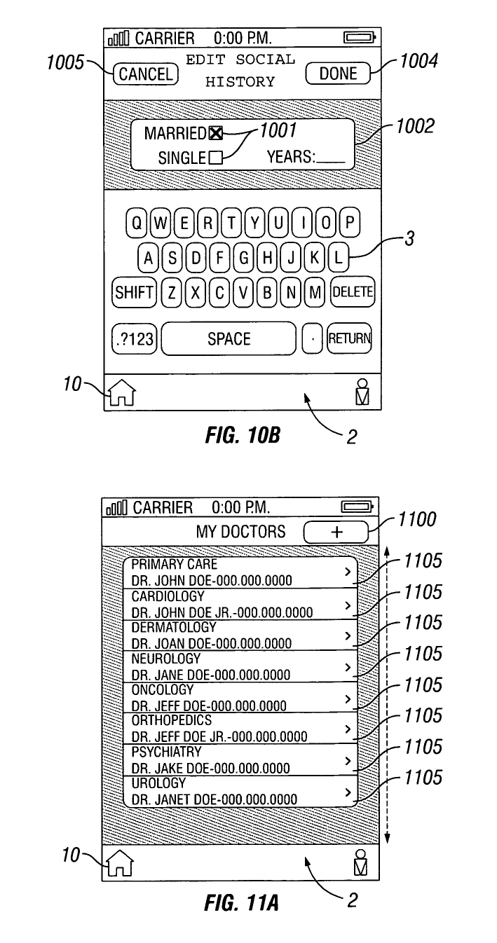

FIG. 10A depicts a preferable software interface for displaying data within the “social history” category. Data within the “social history” category should preferably comprise: marital status and years of marriage, if applicable; occupational status (including a major occupation and years of experience therein); educational level; vices or habits and a brief description thereof, including alcohol consumption, illicit or recreational drug consumption, and addictions (if any). The stated data should preferably compose sectional displays.

Still referring to FIG. 10A, the software interface further comprises command buttons 1000 for adding/editing “social history” data within a particular section of the interface. Preferably, the command button 1000 produces the software interface depicted by FIG. 10B. FIG. 10B preferably comprises data entry elements representing the sectioned data types associated with the selected command button 1000 of FIG. 10A. The data entry elements may preferably be check boxes 1001, drop down lists or list boxes, and text entry boxes 1002. Preferably, the text entry elements might be empty for the addition of data or pre-filled for editing the data.

FIG. 10B exemplarily depicts: check boxes 1001 to indicate whether the user is married or single; and, a text entry box 1002 for indicating the duration of marriage, if applicable. Although not depicted, other data entry elements are preferably as follows: check boxes 1001 to indicate whether the user smokes, and what the user smokes; drop down lists for indicating the employment status, educational level, and the type of alcoholic beverages consumed, if any; and, text entry boxes for the user's occupation and the amount of experience, the timeframe over which the user smoked, the type of smoking if not common, a description of any addictions, and the use of illicit or recreational drugs.

A first drop down list for marital status data preferably may comprise information that includes but is not limited to: “married” or “domestic partnership;” “single;” “widowed;” “divorced;” and, “separated.” A second drop down list for educational level data preferably may comprise information that includes but is not limited to: “less than high school;” “high school;” “college;” “graduate school;” and “professional school.” A third drop down list for the indicating the type of alcoholic beverages consumed by the user preferably may comprise information that includes but is not limited to: “wine;” “beer;” and, “hard liquor.”

Referring again to FIG. 10B, data is preferably entered and edited in the text entry boxes 1002 via a keyboard 3 on the mobile/portable electronic device. Data is preferably entered and edited on the check boxes 1001 and the drop down lists via cursor interaction or via touched selection with the check box 1001 or an item in the drop down list.

The FIG. 10B interface further comprises: (1) a command button 1004 for saving the entered data and (2) a command button 1005 for canceling or deleting data entries. Interaction with either command button 1004, 1005 might preferably return the user to the software interface of FIG. 9A for displaying the data.

FIGS. 1, 10A and 10B provide another example of basic software use. Initially, a first-time user may launch the software and select “social history” from the root menu 100 displayed by the FIG. 1 interface. The activated link preferably produces the FIG. 10A interface. Next, the user might interact with a command button 1000 to produce the interface of FIG. 10B with blank text entry elements for entering the associated data types (i.e., blank check boxes 1001, drop-down lists, or text entry boxes 1002). After data entry, the command button 1004 preferably saves the data and returns the user to the FIG. 10A interface. Finally, the user may return to the root menu or exit the software.

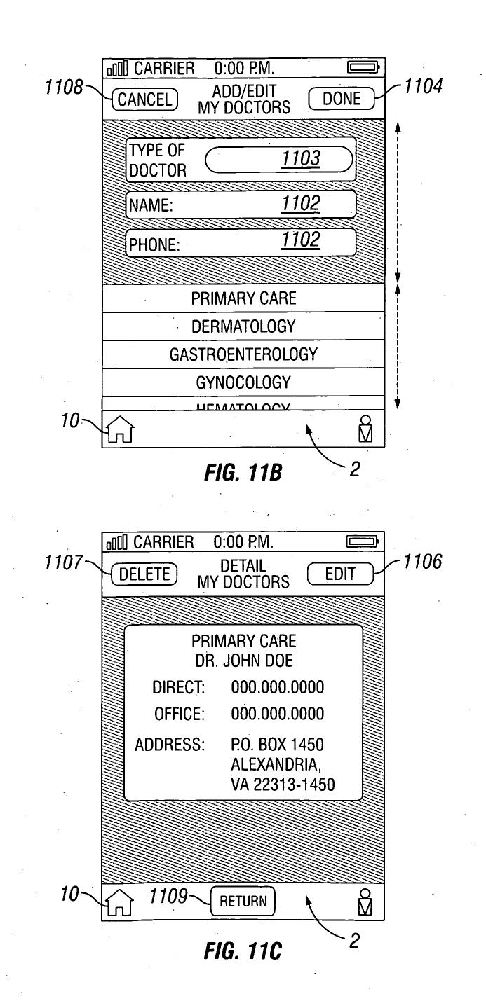

FIG. 11A depicts a preferable software interface for displaying data within the “my doctors” category. Data within the “my doctors” category should preferably comprise: an area of expertise or medicinal practice; the name of the associated doctor; and, the doctor's contact information. FIG. 11A preferably displays a summary of the “My doctors” data alphabetically (according to the doctor's expertise or practice area) except that the first section should be the “primary care” doctor. Preferably, interaction with the phone number associated with a doctor might dial the number for telephonic communication via the mobile/portable electronic device.

Still referring to FIG. 11A, the software interface further comprises: (1) a command button 1100 for adding a section of “my doctor” data and (2) at least one command button 1105 for editing a previously entered data sections. Preferably, interaction with command button 1100 produces the software interface depicted by FIG. 11B and interaction with command button 1105 produces the FIG. 11C interface.

FIG. 11C is a more detailed view of the data associated with the command button 1105. FIG. 11C and features a command button 1106 for producing FIG. 11B to edit the selected data, and a command button 1107 for deleting the selected data. FIG. 11C also features a command button 1109 for returning to the summaries of FIG. 11A.

FIG. 11B is the interface for entering and editing “my doctor” data. FIG. 11B preferably comprises data entry elements that respectively represent the data types within the “my doctors” data category. The data entry elements may preferably be text entry boxes, drop down lists, or list boxes. The text entry elements might be empty for the addition of data (i.e., for command button 1100) or pre-filled for editing the data (i.e., for command button 1105).

FIG. 11B exemplarily depicts text entry boxes 1102 for the name and contact information of the user's doctor, and drop down lists 1103 for the doctor's expertise or practice area. The drop down list 1103 for the doctor's expertise or practice area preferably may comprise information that includes but is not limited to: “primary care;” “dermatology;” “gastroenterology;” “gynecology;” “hematology:” “internal medicine;” “nephrology;” “oncology;” “ophthalmology;” “orthopedics;” “pain therapy;” “pediatrics;” “plastic surgery;” “psychiatry;” “radiology;” “radiological;” “oncology;” “surgery;” “surgery-cosmetic;” “surgery-vascular;” “urology;” and/or any other type of medical expertise or practice.

Still referring to FIG. 11B, data is preferably entered and edited on the drop down list 1103 via cursor interaction or touched selection with an item in the drop down list 1103 as discussed above. Data is preferably entered and edited in the text entry boxes 1102 via a keyboard 3 on the mobile/portable electronic device as discussed above in connection with the other figures.

The FIG. 11B interface further comprises: (1) a command button 1104 for saving the entered data for later display on the FIG. 11A interface and (2) a command button 1008 for canceling new data entries or for deleting old data entries. Interaction with either command button 1104, 1108 preferably returns the user to the software interface of FIG. 11A for displaying the fresh data.

FIGS. 1, 11A through 11C provide another example of basic software use. Initially, a first-time user may launch the software and select “my doctors” from the root menu 100 displayed by the FIG. 1 interface. The activated link preferably produces the FIG. 11A interface. Next, the command button 1100 produces the interface of FIG. 11B with blank text entry elements (i.e., text boxes 1102 and drop-down lists 1103). After data entry, the command button 1104 on the FIG. 7B interface suitably saves the data and produces the FIG. 11A interface with the fresh data summarily displayed thereon. Optionally, interaction with a command button 1105 produces the FIG. 11C interface for a detailed display of the associated data. Command button 1107 preferably permits editing of the associated data via the FIG. 11B interface. After data editing, the command button 1104 preferably saves the modified data entry for display on the FIG. 11A or 11C interface. Also optional, interaction with doctor contact information preferably initiates a phone call, email, or other communication to the doctor. Finally, the user may return to the root menu or exit the software.

FIG. 12A depicts a preferable software interface for displaying data within the “clinical events” category. A “clinical events” is preferably any test procedure, blood test, imaging study, consultation, operation, or any medical event involving the patient. Data entries within the “clinical events” category should preferably comprise: the date of the event; a brief description of the event; the associated doctor's name, if relevant; and, a brief summary of results or main findings. The data is preferably presented by sections, per event. The FIG. 12A interface preferably features a radio button 1200 with options for sorting “clinical events” data chronologically or alphabetically by type of event.

Still referring to FIG. 12A, the software interface further comprises: (1) a command button 1201 for adding a clinical event, and (2) command buttons 1202 for displaying the details of the associated event. Preferably, the command button 1202 produces the software interface depicted in FIG. 12C, wherein a detail of the subject data is displayed. FIG. 12C comprises: a command button 1203 for deleting the associated data; a command button 1204 for editing the associated data; and a command button 1205 for returning the user to the FIG. 12A interface.

Preferably, the command buttons 1201 (FIG. 12A) and 1204 (FIG. 12C) produces the software interface depicted by FIG. 12B. FIG. 12B preferably comprises data entry elements, to respectively represent the data types of a clinical event (i.e., type, date, doctor, and summary/description). The data entry elements may preferably be text entry boxes, drop down lists, or a list box. The text entry elements might be empty for the addition of data (i.e., for command button 1201) or prefilled for the editing of data (i.e., for command button 1204).

FIG. 12B exemplarily depicts text entry boxes 1206 for the doctor's name, date, and clinical event summary, and a drop down lists 1207 for the type of clinical event. In FIG. 12B, the drop down list 1203 for the clinical event type preferably may comprise information that includes but is not limited to: “chest x-ray;” “bone material density;” “colonoscopy;” “consult;” “coronary angiogram;” “echocardiogram;” “EKG;” “emergency room visit;” “hospitalization;” “imaging study” “laboratory;” “medicine;” “pathology;” “radiology;” “stress echocardiogram;” “upper endoscopy;” “other;” and/or, any other indication of clinical event type. The FIG. 12B interface further comprises a command button 1208 for saving the data entry, and a command button 1209 for canceling the data entry.

Data is preferably entered and edited on the drop down list 1103 via cursor interaction with an item in the drop down list 1103 or via touched selection of items in the list 1103 for mobile/portable devices with pressure sensitive displays. Data is preferably entered in the text entry boxes 1206 via a keyboard 3 (as in the previous figures) on the mobile/portable electronic device.

It should be noted that the command button 1201 on the FIG. 12A interface is preferably not the only mechanism for initiating or accomplishing a “clinical events” data entry. Rather, “clinical events” data may be entered programmatically after the addition, modification, or deletion of a data into another data category. More specifically, data entries, modifications, or deletions in the “medications,” “surgeries and injuries,” “hospitalizations,” “allergies or intolerances,” or “immunizations” categories will programmatically produce a data entry in the “clinical events” category. For example, the data modification entry indicating the cessation of Crestor 10 mg medication into the medications database might simultaneously produce a clinical event data entry: “[present calendar date] STOPPED Crestor 10 mg Sig: one daily. Started on [calendar date medication started].”

FIGS. 1 and 12A through 12C provide another example of basic software use. Initially, a first-time user may launch the software and select “clinical events” from the root menu 100 displayed by the FIG. 1 interface. The activated link preferably produces the FIG. 12A interface. Next, the command button 1201 preferably produces the FIG. 12B interface for data entry. After data entry, the command button 1208 preferably saves the data entry and returns the user to the FIG. 12A interface for displaying a summary of the fresh data. Optionally, the command button 1202 suitably produces the FIG. 12C interface for viewing the subject “clinical events” data. Editing the “clinical events” data is preferably initiated via interaction with command button 1204. After data modification, the command button 1208 saves the fresh data and returns the user to the FIG. 12A interface. At any point, the data displayed on the FIG. 12A interface may be sorted alphabetically (by medicine name) or chronologically via the radio button 1200. Finally, the user may return to the root menu or exit the software.

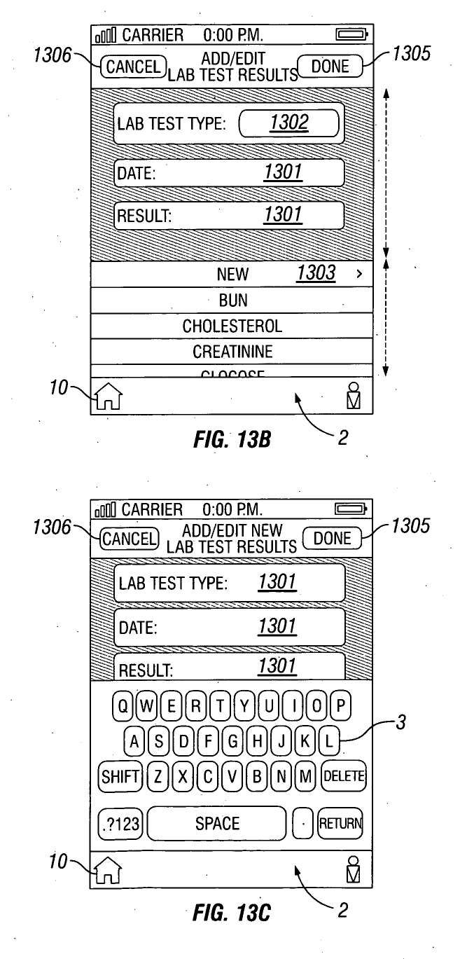

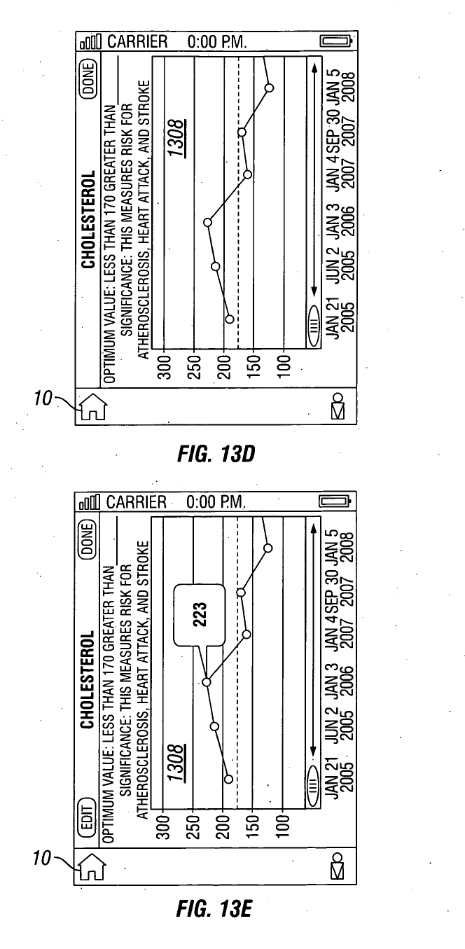

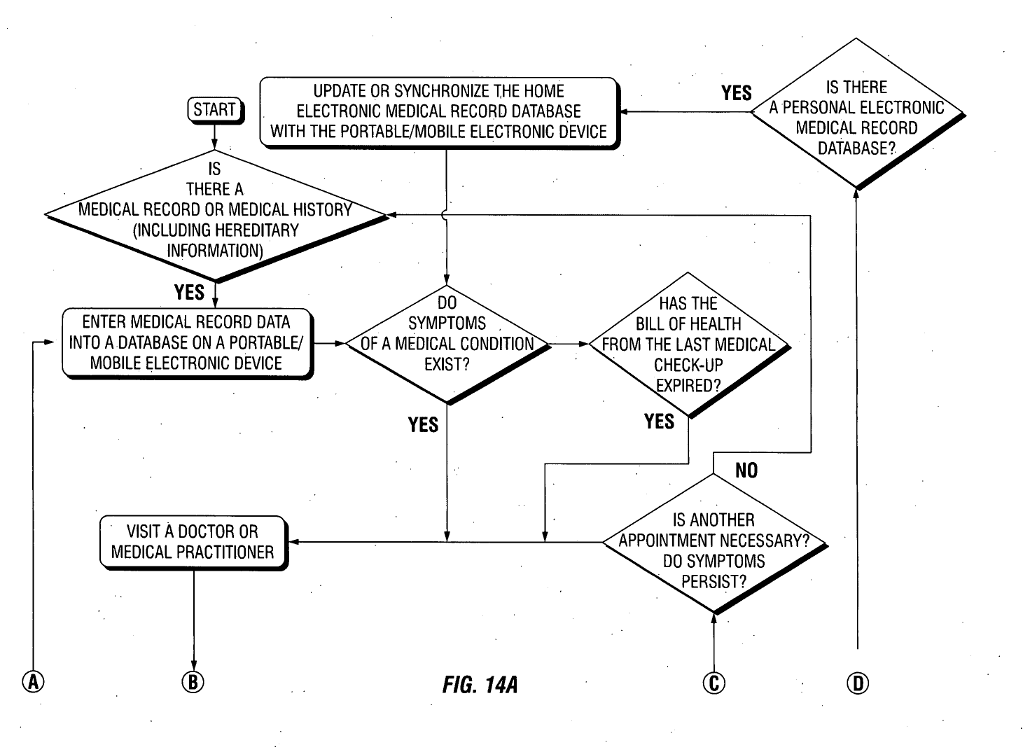

FIG. 13A depicts a preferable software interface for data entry displaying the “lab tests” category. A “lab test” is preferably any physiological, biological, or other measurement of the user's body, for example: bone marrow density; BUN; cholesterol; creatinine; glucose; LDL; hemoglobin; hemoglobin A1C; platelets; sodium; h. pylori, antibody; hs CRP (cardiac CRP); IGF-1; iron; serum; iron binding capacity; iron, percent saturated; lactic acid; LDH; LDL cholesterol; lipase, serum; lithium; lymphocyte count; liver, alk. phosphatase; liver, ALT; liver, AST; liver, bilirubin; magnesium; methylmalonic acid; n-telopeptide, urine; oxygen saturation; parathyroid hormone, intact; phosphorus; platelet count; potassium; prolactin, serum; prothrombin time, INR; PSA; PTT; pulse; pulse pressure, brachial; pulse pressure, aortic; rheumatoid factor; sed. rate; testosterone, total; testosterone, free; thyroid TSH; thyroid T3; thyroid T4; visceral fat, percent; vitamin B12; WBC (white blood cell count). Data entries within the “lab test” category also should preferably comprise: the date of the test; and, the measurement including units.

The software interface of FIG. 13A preferably comprises a command button 1300 for entering a test result. Interaction with command button 1300 preferably produces the software interface of FIG. 13B. FIG. 13B preferably comprises data entry elements (e.g., text boxes 1301 and drop down lists 1302). The text entry boxes 1301 are supplied with data via a keyboard as in the figures above (see also FIG. 13C), and the drop down list 1302 is filled via interaction with a list item. FIG. 13B depicts the drop down list for the lab test type which comprises the lab tests mentioned above. The command button 1305 saves the data entry, while the command button 1306 cancels or deletes the data entry. Interaction with the command button 1305 produces the software interface of FIG. 13D. Interaction with the command button 1306 returns the user to the FIG. 13A interface.

FIG. 13B further comprises the command button 1303 for entering the result of a test that does not compose the drop down list 1302. Interaction with the command button 1303 produces the FIG. 13C interface. FIG. 13C and FIG. 13B are substantially similar in appearance and operation except that the lab test type is entered using a key board 3 plus text entry box 1301 instead of a drop down list 1302. Saved data entries also result in the subject lab test composing the dropdown list 1302 for future data entries.

Referring again to FIG. 13A, the interface further comprises command buttons 1307 associated with a particular lab test for graphically displaying the associated test results via the FIG. 13D interface. FIG. 13D comprises a plot 1308 of the test results (displayed chronologically, not linearly), an indication of an optimum value 1309, an overview of the lab test 1310, and a command button 1311 for returning the user to the FIG. 13A interface.

Still referring to FIG. 13D, the plot 1308 preferably depicts the subject results/measurements versus time (i.e., calendar date of the measurement). The time axis on the plot 1206 is preferably not a linear in time, but rather is relative in time whereby measurements are evenly distributed along the time axis. A scrolling element is preferable for displaying an infinite number of data points in the horizontal and vertical axis.

The FIG. 13D interface also preferably features a text entry box 1309. The text entry box 1309 suitably sets an optimum value for the data points in the plot 1308. The user may suitably identify whether the associated test results/measurements should be above or below the optimum value set in text box 1309. Upon selection of the optimum value, a horizontal line appears on the plot 1308 identifying the optimum value whereby the user may preferably compare the plotted test results/measurements against the optimum value.

Still referring to FIG. 13D, each data point respectively represents a command button for displaying the exact value of the associated data point. Interaction with the data point produces the FIG. 13E interface. FIG. 13E is substantially similar to FIG. 13D except that (1) the exact value of the associated data point is displayed in a new window 1313 over the plot 1308, and (2) a command button 1312 is activated for enabling data edit of the selected data point. Interaction with the command button 1312 preferably produces the FIG. 13B interface for editing the associated data point, as discussed above.

A preferable interface for the “office visits” category is preferably similar to that of the clinical events. However, the office visits preferably permits the audio recording of a comprehensive description of the results of a doctor's office visit or telephone encounter between a patient and a doctor. Audio entries, once entered, may not preferably be altered. The interface may also preferably permit data entry in a text format (i.e., the description may suitably be typed instead of dictated).

A preferable interface for the “reminders” category is preferably similar to a calendaring interface wherein upcoming medical schedulings are recorded. Preferably, the “reminder” category features an alarm mechanism to alert the user when the upcoming reminder is due.

Finally, a preferable interface for the “documents” category is preferably a list of links to documents. Preferably, documents (e.g., scanned copies of: EKG, Breathing test, colonoscopies, echocardiograms, reports of CAT scans, MRI studies, and etcetera) will be stored in the memory of the portable/mobile device and a link provided on the software interface. Like the other list interfaces discussed above, the document may preferably be sorted chronologically or alphabetically. Activating the link preferably produces the documents image on the visual output display of the device.

It should be noted that the device might feature mirrored software on a desktop, laptop, or any other type of computer. Data might be entered, modified, edited, deleted, and manipulated on any number of computers or portable/mobile electronic devices. Subject thereto, all devices and computers might preferably be synchronized whereby the data entries on all devices and computers are matched and updated accordingly. In other words, a data entry on the computer can preferably be synced to the portable/mobile device without manually entering the data on both systems. It is also contemplated that a printer may be introduced to the computer or the mobile/portable device for printing hard copies of the entered data.

FIG. 15.1 through 15.21 depict preferable embodiments of the software interfaces discussed above in connection with FIGS. 1 through 13E.

In yet another embodiment, it is contemplated that the above described system employ three separate software versions installed at various locations, yet employing the data entry and software interfaces discussed above. The three software versions are as follows: a first version on a medical patient's mobile/portable device as discussed above; a second version on the medical patient's computer; and a third version on the computer or mobile/portable device of the patient's medical consults and practitioners. As discussed above, the first version would preferably feature the patient's complete and concise medical record for elective recall wherever the patient is located (for example, military personal stationed in the far reaching areas of the globe). The second version would preferably feature the patient's complete and concise medical records for elective recall or entry at the patients living quarters. New data entered by the patient into either the first or second version could be synchronized to both versions programmatically. Finally, the third version could be placed at a computer in the patient's doctor's office. Rather than fill out cumbersome paper work, the patient could provided the doctor with the mobile device and synchronize the first and third versions programmatically. After a medical exam, the doctor could provide the third version with the resultant medical data and then synchronize the fresh data to the patient's first version on the mobile/portable device.

Preferably, the third version is password protected according to a password selected by the user. In other words the doctor may not synchronize the third version with data from the first version, and vice versa, without permission from the patient. This ensures that the doctor cannot add or change data, like, for example, to hide his/her malpractice. Furthermore, changes made to the data, if ever should be logged and made available for disclosure.

In yet another embodiment of the third version, the software is installed on the patient's medical practitioner's mobile/portable device whereby the practitioner may, in anticipation of the patients consult, access the patients data thereon the mobile/portable device. Further, such an embodiment would permit the practitioner to dictate the office visit summary for the patient, including recommendations or reminders (e.g., follow-ups, lab tests, procedures, and consultations), while the patient is still in the examination room. The data recorded by the doctor may be uploaded or synchronized to the second or first version as disclosed above.

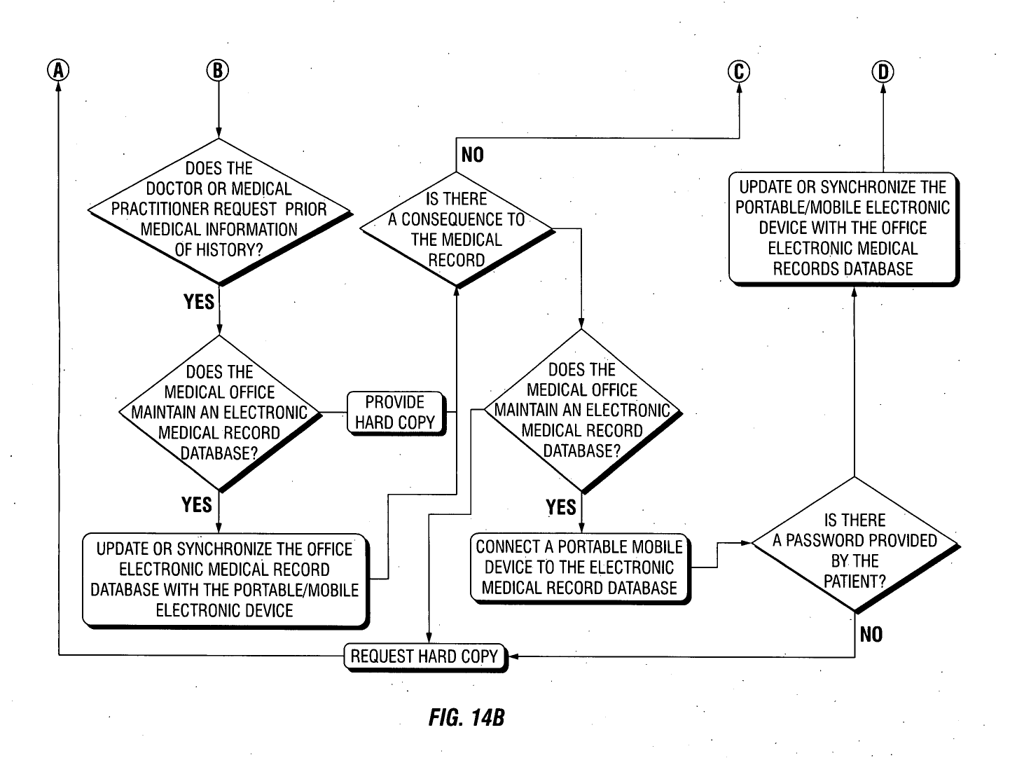

A typical flow diagram for the above stated three version synchronization is attached as FIG. 14.

In yet another embodiment, it is contemplated that the above described system employs a fourth version of the software to be preferably stored and maintained on the internet, yet employing the data entry and software interfaces discussed above. The internet version is preferably substantially similar to the second version discussed above, except that a user may access the software from any computer via the internet (i.e., anywhere in the world). Synchronization will be a preferable option between the fourth version and any of other three versions previously discussed. As with the other three versions, the fourth version has suitable data security provisions, including conformity with the HIPAA federal requirements (e.g., encryption, password controls, and etcetera).

In addition, it is contemplated that all four versions may feature an additional memory for storing notes within a patient's medical record that are of particular importance. For example, a doctor's notes documenting a particular office visit or encounter (including recommendations and follow up), a doctor's assessment of a laboratory test and other procedures, and etcetera, may be particularly important. In a first embodiment, the notes are maintained in a text format for recall and view via the software interface and the computer output display. In another embodiment, the notes are preferably maintained in a voice recorded format for audio recall. Notes may be input into any of the four software versions by either a patient or a doctor in the preferable manner of data entry discussed above. For example, a doctor may compose a note and enter the note (whether audio or text format) into the third version. In a preferable example, a patient provides a mobile/portable device featuring a first version of the software to a doctor who dictates the note directly into the portable/mobile device. Subsequently, notes may preferably be synchronized to the other software versions.

Relatedly, the four versions shall preferably feature communicative functionality whereby a doctor may communicate quickly with the patient. For example, a doctor may transmit a particular report prepared for the patient, reminders, and recommendations via the third version to the first, second or fourth versions.

In summary, the present application may be a method for logging, tracking, storing, and/or accessing personal medical information on a portable/mobile electronic device. The methods include, but are not limited to the steps of: categorizing data entry into at least one database; programmatically manipulating the data to produce further categorized and automatic data entries; and synchronizing the data entry with a personal computer or the doctor's computer. In another embodiment, personal medical records maintained by a doctor on an office computer are synchronized to a patient's portable/mobile electronic device for electronic communication to the office computer of another doctor. In yet another embodiment, the results of lab tests are logged on the test subject's portable/mobile device and programmatically manipulated for graphical or coordinated display whereby, over time, the user may identify trend in the test results, extrapolate the test results for predicting medical consequences of the trend, and set goals or plans for influencing subsequent test results.

It is also contemplated that the present invention is a system for storing personal medical information on a portable/mobile device comprising: personal medical record data; a data input/entering means; a portable/mobile device having a memory; a dedicated means for programmatically manipulating the data or plotting the data; a dedicated means for electively displaying the medical data from the memory; memory external to said mobile/portable device; and, a dedicated means for synchronizing the data with the external memory.

It should be noted that FIGS. 1 through 15.21 and the associated descriptions are of illustrative importance only. In other words, the depictions and descriptions of the present invention should not be construed as limiting of the subject matter in this application. The apparatuses, assemblies, components, and methods discussed hereby are susceptible to modification without changing the overall concept of the disclosed invention. Such modifications might become apparent to one skilled in the art after reading this disclosure.

I claim:

1. A system for logging and/or tracking personal medical information comprising:
a first computer hardware that is coupled to a first database and which includes program code;
a second computer hardware that is coupled to a second database and which includes program code;
wherein a first set of program code on the first and second computer hardware is configured to provide user interaction through the presentation of a data entry interface, receive user inputs regarding a patient's medical information, and categorically populate the database with the inputs;
wherein a second set of program code on the first and second computer hardware is configured to present at least one recall interface for fetching and categorically presenting the inputs; and,
wherein a third set of program code on the first and second computer hardware is configured to synchronize the populations of the first and second databases.

2. The system of claim 1 wherein the first computer hardware is a component of a portable electronic device.

3. The system of claim 2 wherein the second computer hardware is located in the home of the patient.

4. The system of claim 2 wherein the second computer hardware is located in the office of the patient's medical practitioner.

5. The system of claim 2 wherein the second computer hardware is a component of a server.

6. The system of claim 1 wherein the inputs are data within a category selected from the group consisting essentially of personal data, major diagnoses, current medications, surgeries or injuries, hospitalizations, allergies or intolerances, immunizations, hereditary data or family history, doctors or hospitals, clinical events, lab tests or test results; office visits, reminders, and documents.

7. A method for logging, tracking, storing, and/or accessing personal medical information on a portable/mobile electronic device comprising the steps of:
categorizing data entry of medical information into at least one database on the computer hardware of the electronic device via software installed thereon and configured for this purpose;
manipulating the data via the software to produce further categorized and automatic data entries; and,
synchronizing the data entry via the software with a personal computer or a doctor's computer with a copy of the software installed thereon the computer hardware of the personal computer or doctor's computer.

8. The method of claim 7 wherein the medical information is within a category selected from the group consisting essentially of personal data, major diagnoses, current medications, surgeries or injuries, hospitalizations, allergies or intolerances, immunizations, hereditary data or family history, doctors or hospitals, clinical events, lab tests or test results; office visits, reminders, and documents.

9. A portable electronic device comprising:
computer hardware coupled to a database, the computer hardware having software installed thereon;
wherein the software is configured with a root menu, the root menu comprised of at least one menu item defining a link and a command button for activating the link;
wherein the menu item defines a medical information category; and,
wherein the software is further configured to present a display of information within the associated medical information category whenever the link is activated, the display featuring a command button for presenting a virtual QWERTY keyboard for allowing data entry via the keyboard and a command button for populating the database with the data entry so that the information presented on the display comprises the data entry, the display further featuring a command button for activating a link to the root menu.

10. The device of claim 9 wherein the menu item(s) is selected from a category in the group consisting essentially of personal data, major diagnoses, current medications, surgeries or injuries, hospitalizations, allergies or intolerances, immunizations, hereditary data or family history, doctors or hospitals, clinical events, lab tests or test results; office visits, reminders, and documents.

11. The device of claim 9 wherein the menu item(s) is personal data and the data entry is information selected from the group consisting essentially of: the calendar date of the most recent data input or modification; the user's name; the user's address; the user's phone number (day and night); the user's calendar date of birth; the user's primary and secondary insurance carriers; the user's primary insurance identification or policy number; the user's pharmacy of choice and the associated telephone number; the users; height, weight, gender, and body mass index (including the associated interpretation); the user's emergency contact information including the contact's name, relationship to the user, and telephone number; and whether the patient has a living will or not.

12. The device of claim 9 wherein the software is configured to use the data entry for automatically producing a different data entry.

13. The device of claim 9 wherein the menu item(s) is medications and the data entry is information selected from the group consisting essentially of: the name, strength or dose, administration instructions, and the calendar date for initial administration of any prescription or over the counter drugs (suitably including vitamins, supplements, and the like) administered to the data entrant.

14. The device of claim 13 wherein the associated display comprises a radio button with options for sorting the “current medications” data displayed thereby.

15. The device of claim 14 wherein the associated software features a search engine linked to the current medications data whereby activating the link submits a search query to the search engine with the medications data being the search term.

16. The device of claim 9 wherein the menu item(s) is test results and the data entry is at least one result of a clinical test.

17. The device of claim 16 wherein the software is configured to plot the data entries on an x-y graph and wherein the display is plotted data entries.

18. The device of claim 9 wherein the software is configured to synchronize the database population with another database population on a database coupled to the computer hardware of a personal computer that has been installed with like software.

19. The device of claim 9 wherein the software is configured to receive a voice dictated data entry

20. The device of claim 9 wherein the software is configured with password protection for access to the root menu.
